(19) United States
(12) Patent Application Publication
(10) Pub. No.: US 2026/0175170 A1
(43) Pub. Date: Jun. 25, 2026

(54) PROCESSES AND APPARATUSES FOR REDUCING INTERNAL DAMAGE IMPAIRMENT TO AN EQUIPMENT PIECE IN A CARBON CAPTURE UNIT

(71) Applicant: UOP LLC, Des Plaines, IL (US)

(72) Inventors: Aziz Sattar, Itasca, IL (US); Michael R. Van de Cotte, Palatine, IL (US); Karthikk Sridharan, Tulsa, OK (US); Jeffrey Tyska, Roselle, IL (US); Anh Ngo, Cypress, TX (US)

(21) Appl. No.: 19/340,498

(22) Filed: Sep. 25, 2025

Related U.S. Application Data
(60) Provisional application No. 63/736,877, filed on Dec. 20, 2024.

(51) Int. Cl. B01D 53/62; B01D 53/04

(52) U.S. Cl. CPC B01D 53/62; B01D 53/0438; B01D 53/0446; B01D 2257/504; B01D 2258/06

(57) ABSTRACT

Processes and apparatuses for reducing internal damage impairment to an equipment piece in a carbon capture unit after shutdown of the carbon capture unit with a purge gas. Once a shutdown of the carbon capture unit has been detected purge gas is used to displace process fluid within spaces of the equipment piece. The carbon capture unit may be a cryogenic carbon capture unit, a solvent carbon capture unit, a membrane carbon capture unit, a solid adsorbent carbon capture unit, or any combination thereof.

### RELATED APPLICATIONS

This application claims priority to United States Provisional Patent Application Ser. No. 63/736,877, filed on Dec. 20, 2024, the entirety of which is incorporated herein by reference.

### FIELD OF THE INVENTION

This invention relates generally to processes and apparatuses for reducing internal damage impairment to an equipment piece in a carbon capture unit after shutdown of the carbon capture unit with a purge gas.

### BACKGROUND OF THE INVENTION

In order to reduce greenhouse emissions and reduce potential climate change, it is desirable to limit the amount of carbon dioxide (CO₂) emitted to the atmosphere. One important technology for emissions abatement is carbon capture.

Many chemical processes and plants produce various flue gas streams that contain carbon dioxide. Before the flue gas is processed in a carbon capture processing unit, the flue gas passes through various equipment pieces such as compressors and heat exchangers. Flue gas contains particulate matter that could be deposited on rotating and static surfaces in the equipment pieces including quiescent areas and areas of small clearance and passages. For example, in a cement plant or steel plant, flue gas from cement kiln or blast furnace may contain particulates that may adhere to internal surfaces of equipment and form solids under certain conditions.

During operation, the equipment piece has an increased temperature and a gas flow which means that the particles are not likely to form solids. However, during a shutdown, residual moisture may become trapped in the equipment piece and condense as it cools, causing the deposited particulates, potentially including but not limited to CaO, MgO, K₂CO₂, MgCO₂ and CaCO₃ to hydrate and harden or solidify. Concurrently, the thermal mass of rotating and static equipment will naturally cool down at shutdown after having been operated at temperature above ambient. The residual heat may accelerate the hardening of particulate matter causing it to dry out faster.

The hardening of particulate matter may reduce the gap between adjacent components within the rotating equipment leading to additional friction impacting performance of equipment such ability to deliver required pressure and/or flow and/or more power draw on drivers and/or higher than planned discharge temperatures. The hardening of the particulate matter may also introduce unbalanced mass to rotating equipment leading to vibration and eventual failure of equipment. Additionally, such hardened material fouls heat exchanger surfaces leading to reduction in thermal performance and/or increase in pressure drop. Accordingly, it would be desirable to reduce or eliminate this possibility.

Of particular concern is the feed compressor of carbon capture plant placed just downstream of polishing scrubbing/filtration equipment as it the first rotating equipment to process flue gas with uncaptured particulate matter. The feed compressor may be one of the highest priced pieces of equipment in the plant and have the greatest influence on plant reliability and uptime. Thus, any impairment to the feed compressor can have significant impacts beyond needing to repair the equipment piece.

Additionally, any particulate matter that is not removed by scrubber/filter or deposited on feed compressor will pass downstream. Some particulate matter may be captured within drier/guard beds, while some may pass to various heat exchangers within the plant, such as compressor interstage coolers. In any of these heat exchangers, regardless of position, the particulate matter is likely to cause fouling within the heat exchange over time resulting in reduced thermal performance. The heat exchanger may be shell and tube type as well as plate fin heat exchangers. Plate fin heat exchangers are common in cryogenic carbon capture units and have small passages that are difficult to clean if fouled. They are often brazed/welded construction and cannot be disassembled for cleaning access. Thus, fouled heat exchangers may require repair or replacement.

Finally, any moisture that condenses within feed compressor and/or welded heat exchangers following a shutdown where particulate is already present may cause additional hardening over time. In other words, a fouled heat exchanger will likely continue to foul and continue to decrease performance over time.

Accordingly, it would be desirable to have effective and efficient processes for suppressing the likelihood of particulate matter hardening inside of equipment pieces as a result of a shutdown.

### SUMMARY OF THE INVENTION

Processes and apparatuses for reducing internal damage to an equipment piece in a carbon capture unit after shutdown of the carbon capture unit have been invented. According to the various embodiments, a purge gas is utilized to quickly evacuate the residual gas containing moisture from the equipment upon shutdown.

Therefore, the present invention may be characterized, in at least one aspect, as providing a process for reducing internal impairment to an equipment piece in a carbon capture unit after shutdown of the carbon capture unit, wherein the equipment piece comprises a space configured to receive a process stream for the carbon capture unit, the process comprising: introducing a purge gas to the equipment piece so as to displace any fluid from the process stream in the space.

The introducing may be performed immediately after shutdown.

The introducing may be performed after shutdown before a temperature in the space of the equipment piece reaches a dew point of the process stream.

The equipment piece may be a compressor, a heat exchanger, or an expander.

The carbon capture unit may include a cryogenic carbon capture unit, a solvent carbon capture unit, a membrane carbon capture unit, a solid adsorbent carbon capture unit, or any combination thereof.

The purge gas may be nitrogen, oxygen, argon, helium, carbon dioxide, air with a dew point below a final temperature of the equipment, or a combination thereof.

The purge gas may be produced by the carbon capture unit.

The purge gas may be produced by the carbon capture unit, and the purge gas may be stored in a vessel at an elevated pressure compared to the space such that the space is purged when needed.

The purge gas may be introduced with a blower or a fan fluidically connected to the equipment piece piping.

The introducing may be performed automatically when a shutdown occurs.

The process may further include determining a moisture content of the displaced fluid. The process may then also include introducing the purge gas so long as the moisture content is above a threshold.

In a second aspect the present invention may be generally characterized as providing a process for reducing internal impairment to an equipment piece in a carbon capture unit after shutdown of the carbon capture unit, wherein the equipment piece comprises a space configured to receive a process stream for the carbon capture unit, the process includes: determining a shutdown of the carbon capture unit has occurred; introducing a purge gas to the equipment piece so as to displace any fluid from the process stream in the space; determining a moisture content of the displaced fluid; and, introducing the purge gas so long as the moisture content is above a threshold.

The carbon capture unit may be a cryogenic carbon capture unit, a solvent carbon capture unit, a membrane carbon capture unit, a solid adsorbent carbon capture unit, or any combination thereof.

The purge gas may be produced by the carbon capture unit.

The purge gas may be stored in a vessel at an elevated pressure relative to a pressure of the space.

The purge gas may be nitrogen, oxygen, argon, helium, carbon dioxide, air with a dew point below a final temperature of the equipment, or combinations thereof.

In a third aspect the present invention may be generally characterized as providing an having comprising: a carbon capture unit comprising an equipment piece with a space configured to receive a process stream for the carbon capture unit; and, a controller configured to: determine a shutdown of the carbon capture unit has occurred; and, cause a purge gas to be introduced to the equipment piece so as to displace any fluid from the process stream in the space.

The apparatus may further include a sensor configured to be utilized to determine a moisture content of the displaced fluid. The controller may be further configured to stop a flow of the purge gas when the moisture content of the displaced fluid has been determined to be below a threshold.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

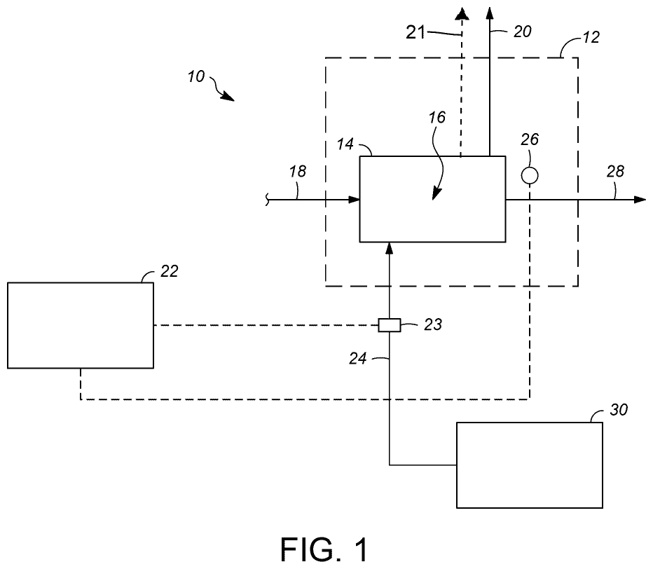

FIG. 1 shows a schematic diagram of an apparatus according to one or more embodiments of the present application.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention. In general, the same reference numbers will be used throughout the drawing(s) and accompanying written description to refer to the same or like parts.

### DETAILED DESCRIPTION OF THE INVENTION

As mentioned above, processes and apparatuses for reducing internal damage to an equipment piece in a carbon capture unit after shutdown of the carbon capture unit have been invented. It is contemplated that the equipment is purged with a purge gas that is free of moisture until most, if not all, of the moisture has been evacuated. Preferably, the purge gas is an inert gas like nitrogen, helium and/or argon, and most preferably the purge gas is produced by the carbon capture unit and/or processing plant with the carbon capture unit. It is also contemplated that air, with a low enough dewpoint below the temperature of the equipment, such as −40° C., is used. The purge gas may also include carbon dioxide, which may be provided from the carbon capture unit. The process may be automated not just for convenience but also in case a shutdown occurs when an operator is unavailable to manually perform purging operation.

The purge gas is substantially inert relative to rotating and static equipment metallurgy and particulate matter and can be sourced from a plant wide system having a high reliability and uptime such that operator is assured that purge is completed.

It is possible that an inert purge gas is not readily available. An on-purpose fan or blower may be connected to rotating and static equipment piping that is operated after the shutdown. This could be installed upstream of the subject equipment and draws dry, filtered air and pushes it through the equipment volume and thus purging it as well as cooling it fast reducing likelihood of particulate matter hardening. Additionally and/or alternatively, this could be installed downstream of rotating and static equipment and draw the residual gas and moisture trapped with the equipment out and thus purging it as well as cooling it fast reducing likelihood of particulate matter hardening.

A fan or blower may be connected and wetted by process piping, operated after the shutdown and may be installed upstream or downstream of the equipment piece to introduce purge gas and displace the residual process gas containing moisture that would otherwise sits idle in the equipment and condense.

It is contemplated that an on-purpose inert gas generator, such a nitrogen generator, is utilized to provide a continuous source of purge gas for extended purge duration.

It is also contemplated that the purge gas includes CO₂ rich gas produced in the carbon capture unit.

Additionally or alternatively, CO₂ can be sourced from CO₂ storage and is available at large volume. CO₂ is stored as a liquid at cryogenic conditions and there is boil off due to heat input from the surrounding environment at ambient temperatures. The boil-off process cause storage tank pressure to increase and to maintain a stable tank pressure, the CO₂ boil off is vented to liquefaction section of the plant to re-convert gas back to liquid. Instead of sending boil-off CO₂ for liquefaction, the CO₂ boil-off gas can be used as purged gas for the equipment.

A purge gas source, containing a preferably pressurized purge gas, may be provided to be utilized for purging and/or cooling. The purge gas source can be sized to provided volume and duration of purging the equipment internal volume as well as to cooling it fast reducing likelihood of particulate matter hardening. An advantage of using pressurized volume is that it can be routed to the equipment through a fail open valve such that action is performed even in case of power failure or failure of program logic controller or communication cabling that sends signal from controller to valve.

It is desirable to provide, if possible, assurance that the equipment volume is purged of moisture as failure of purging or incomplete purging can lead to extended shutdown to remove hardened particulate matter. Accordingly, sensors and sensor-based actions may be utilized. For example, a sensor may be provided to measure inlet and outlet flow of purge gas. A sensor may be provided to measure moisture content in evacuated gas. A sensor to measure moisture/dewpoint of purge gas itself. One or more sensors may be provided to determine that there is a sufficient volume or pressure of purge gas to execute the purging operation and prevent start-up of equipment if not.

Alerts can be made when, for example, the purge gas source (container) is empty or has insufficient volume or pressure to completely execute the next purging operation.

It is contemplated that the present processes and apparatuses function even when the shutdown may be caused by a loss of power. For example, a backup power source may be provided to supply power to a purge gas generator or source, one or more controllers, one or more sensors, a fan or blower for the purge gas, and any electrically actuated valves. If the purge gas generator or source is a container with pressurized purge gas, no fan or blower may be required. If a power loss is detected, the apparatus would automatically purge the associated equipment.

With these general principles in mind, one or more embodiments of the present invention will be described with the understanding that the following description is not intended to be limiting.

In FIG. 1, an apparatus 10 is depicted. The apparatus includes a carbon capture unit 12 having an equipment piece 14 with a space 16 configured to receive a process stream 18 for the carbon capture unit 10. Thus, a CO₂ lean process stream 20 from the carbon capture unit 12 has a lower concentration of carbon dioxide compared with the process stream 18 sent to the carbon capture unit 12 for processing. It is contemplated that the process stream 18 is formed, at least partially, from a flue gas. The carbon capture unit 12 may produce a CO₂ product stream 21.

Carbon capture units 12 are known and may include one or more vessels with a chemical solvent, one or more vessels with a solid sorbent, a membrane, or a cryogenic fractionation column.

The apparatus 10 also includes a controller 22 which is configured to determine a shutdown of the carbon capture unit 12 has occurred and, in response to that determination, cause a purge gas 24 to be introduced to the equipment piece 14 so as to displace any fluid from the process stream 18 in the space 16. For example, the controller 22 may be in communication with a valve 23 and once a shutdown has been detected or determined to have occurred, a signal could be sent to the valve 23 to open to start the flow of the purge gas 24 to the piece of equipment 14. A shutdown may be determined or detected in response to a signal sent from a person or a sensor or other controller.

The purge gas 24 may be introduced immediately after a shutdown is detected or determined to have occurred. Preferably, the purge gas 24 is introduced after shutdown and before a temperature in the space 16 of the equipment piece 14 reaches a dew point of the process stream 18. It is also contemplated, although not required, that the introducing of the purge gas 24 occurs automatically when a shutdown is detected or determined to have occurred.

The equipment piece 14 may be, for example, a compressor, a heat exchanger like a cooler, an expander, a valve, or the like. Additionally, the carbon capture unit 10 may have multiple equipment pieces 14 and therefore, it is contemplated that each equipment piece 14 receives, or at least multiple equipment pieces 14 receive, the purge gas 24.

The apparatus may include a sensor 26 configured to be utilized to determine a moisture content of the displaced fluid 28. Thus, the controller 22, the sensor 26, or another device may determine the moisture content of the displaced fluid 28. With information about the moisture content of the displaced fluid 28, the controller 22 may also be configured to stop a flow of the purge gas 24 when the moisture content of the displaced fluid 28 has been determined to be below a threshold. In other words, as long as the moisture content is above a threshold level, the controller 22 may permit the purge gas 24 to be introduced into the equipment piece 14.

The purge gas 24 is preferably an inert gas that is readily available or easily available. It is contemplated that the purge gas 24 may include nitrogen, argon, helium, carbon dioxide, air with a dew point below a final temperature of the equipment, and combinations thereof. Accordingly, the apparatus 10 may include a source 30 of the purge gas 24.

The source 30 of the purge gas 24 may be a tank or vessel that is filled with purge gas. Alternatively, the source 30 of the purge gas 24 may be a piece of equipment that generates the purge gas 24, either on demand, or as a part of a different process. For example, the purge gas 24 may include carbon dioxide, and the source 30 of the purge gas 24 may be the carbon capture unit 12 (for example with CO₂ product stream 21). Similarly, the source 30 of the purge gas 24 may be a nitrogen gas generator. The purge gas 24 is preferably at an elevated pressure compared to a pressure of the space 16.

The purge gas 24 may be introduced with a blower or a fan fluidically connected to the equipment piece 14 via separate piping. Additionally, or alternatively, the purge gas 24 may introduced into the equipment piece 14 through the piping for the process stream 18.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be utilized to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps.

For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### Specific Embodiments

While the following is described in conjunction with specific embodiments, it will be understood that this description is intended to illustrate and not limit the scope of the preceding description and the appended claims.

A first embodiment of the invention is a process for reducing internal impairment to an equipment piece in a carbon capture unit after shutdown of the carbon capture unit, wherein the equipment piece comprises a space configured to receive a process stream for the carbon capture unit, the process comprising introducing a purge gas to the equipment piece so as to displace any fluid from the process stream in the space. An embodiment of the invention is one, any or all of prior embodiments in this paragraph up through the first embodiment in this paragraph, wherein the introducing is performed immediately after shutdown. An embodiment of the invention is one, any or all of prior embodiments in this paragraph up through the first embodiment in this paragraph, wherein the introducing is performed after shutdown before a temperature in the space of the equipment piece reaches a dew point of the process stream. An embodiment of the invention is one, any or all of prior embodiments in this paragraph up through the first embodiment in this paragraph, wherein the equipment piece comprises a compressor, a heat exchanger, or an expander. An embodiment of the invention is one, any or all of prior embodiments in this paragraph up through the first embodiment in this paragraph, wherein the carbon capture unit comprises a cryogenic carbon capture unit, solvent carbon capture unit, membrane carbon capture unit, solid adsorbent carbon capture unit or a carbon capture unit combining one or more of the approaches above. An embodiment of the invention is one, any or all of prior embodiments in this paragraph up through the first embodiment in this paragraph, wherein the purge gas is selected from a group consisting of nitrogen, oxygen, argon, helium, carbon dioxide, air with a dew point below a final temperature of the equipment, and combinations thereof. An embodiment of the invention is one, any or all of prior embodiments in this paragraph up through the first embodiment in this paragraph, wherein the purge gas is produced by the carbon capture unit. An embodiment of the invention is one, any or all of prior embodiments in this paragraph up through the first embodiment in this paragraph, wherein the purge gas is produced by the carbon capture unit, and wherein the purge gas is stored in a vessel at an elevated pressure. An embodiment of the invention is one, any or all of prior embodiments in this paragraph up through the first embodiment in this paragraph, wherein the purge gas is introduced with a blower or a fan fluidically connected to the equipment piece piping. An embodiment of the invention is one, any or all of prior embodiments in this paragraph up through the first embodiment in this paragraph, wherein the introducing is performed automatically when a shutdown occurs. An embodiment of the invention is one, any or all of prior embodiments in this paragraph up through the first embodiment in this paragraph, further comprising determining a moisture content of the displaced fluid. An embodiment of the invention is one, any or all of prior embodiments in this paragraph up through the first embodiment in this paragraph, further comprising introducing the purge gas so long as the moisture content is above a threshold.

A second embodiment of the invention is a process for reducing internal impairment to an equipment piece in a carbon capture unit after shutdown of the carbon capture unit, wherein the equipment piece comprises a space configured to receive a process stream for the carbon capture unit, the process comprising determining a shutdown of the carbon capture unit has occurred; introducing a purge gas to the equipment piece so as to displace any fluid from the process stream in the space; determining a moisture content of the displaced fluid; and, introducing the purge gas so long as the moisture content is above a threshold. An embodiment of the invention is one, any or all of prior embodiments in this paragraph up through the second embodiment in this paragraph, wherein the carbon capture unit comprises a cryogenic carbon capture unit, solvent carbon capture unit, membrane carbon capture unit, solid adsorbent carbon capture unit or a carbon capture unit combining one or more of the approaches above. An embodiment of the invention is one, any or all of prior embodiments in this paragraph up through the second embodiment in this paragraph, wherein the purge gas is produced by the carbon capture unit. An embodiment of the invention is one, any or all of prior embodiments in this paragraph up through the second embodiment in this paragraph, wherein the purge gas is stored in a vessel at an elevated pressure. An embodiment of the invention is one, any or all of prior embodiments in this paragraph up through the second embodiment in this paragraph, wherein the purge gas is selected from a group consisting of nitrogen, oxygen, argon, helium, carbon dioxide, air with a dew point below a final temperature of the equipment, and combinations thereof.

A third embodiment of the invention is an apparatus comprising a carbon capture unit comprising an equipment piece with a space configured to receive a process stream for the carbon capture unit; and, a controller configured to determine a shutdown of the carbon capture unit has occurred; and, cause a purge gas to be introduced to the equipment piece so as to displace any fluid from the process stream in the space. An embodiment of the invention is one, any or all of prior embodiments in this paragraph up through the third embodiment in this paragraph, further comprising a sensor configured to be utilized to determine a moisture content of the displaced fluid. An embodiment of the invention is one, any or all of prior embodiments in this paragraph up through the third embodiment in this paragraph, wherein the controller is further configured to stop a flow of the purge gas when the moisture content of the displaced fluid has been determined to be below a threshold.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for reducing internal impairment to an equipment piece in a carbon capture unit after shutdown of the carbon capture unit, wherein the equipment piece comprises a space configured to receive a process stream for the carbon capture unit, the process comprising:
introducing a purge gas to the equipment piece so as to displace any fluid from the process stream in the space.

2. The process of claim 1, wherein the introducing is performed immediately after shutdown.

3. The process of claim 1, wherein the introducing is performed after shutdown before a temperature in the space of the equipment piece reaches a dew point of the process stream.

4. The process of claim 1, wherein the equipment piece comprises a compressor, a heat exchanger, or an expander.

5. The process of claim 1, wherein the carbon capture unit comprises a cryogenic carbon capture unit, a solvent carbon capture unit, a membrane carbon capture unit, a solid adsorbent carbon capture unit, or any combination thereof.

6. The process of claim 1, wherein the purge gas is selected from a group consisting of: nitrogen, oxygen, argon, helium, carbon dioxide, air with a dew point below a final temperature of the equipment, and combinations thereof.

7. The process of claim 1, wherein the purge gas is produced by the carbon capture unit.

8. The process of claim 1, wherein the purge gas is produced by the carbon capture unit, and
wherein the purge gas is stored in a vessel at an elevated pressure relative to a pressure of the space.

9. The process of claim 1, wherein the purge gas is introduced with a blower or a fan fluidically connected to the equipment piece piping.

10. The process of claim 1, wherein the introducing is performed automatically when a shutdown occurs.

11. The process of claim 1, further comprising:
determining a moisture content of the displaced fluid.

12. The process of claim 11, further comprising:
introducing the purge gas so long as the moisture content is above a threshold.

13. A process for reducing internal impairment to an equipment piece in a carbon capture unit after shutdown of the carbon capture unit, wherein the equipment piece comprises a space configured to receive a process stream for the carbon capture unit, the process comprising:
determining a shutdown of the carbon capture unit has occurred;
introducing a purge gas to the equipment piece so as to displace any fluid from the process stream in the space;
determining a moisture content of the displaced fluid; and,
introducing the purge gas so long as the moisture content is above a threshold.

14. The process of claim 13, wherein the carbon capture unit comprises a cryogenic carbon capture unit, a solvent carbon capture unit, a membrane carbon capture unit, a solid adsorbent carbon capture unit, or any combination thereof.

15. The process of claim 13, wherein the purge gas is produced by the carbon capture unit.

16. The process of claim 15, wherein the purge gas is stored in a vessel at an elevated pressure relative to a pressure of the space.

17. The process of claim 13, wherein the purge gas is selected from a group consisting of: nitrogen, oxygen, argon, helium, carbon dioxide, air with a dew point below a final temperature of the equipment, and combinations thereof.

18. An apparatus comprising:
a carbon capture unit comprising an equipment piece with a space configured to receive a process stream for the carbon capture unit; and,
a controller configured to:
determine a shutdown of the carbon capture unit has occurred; and,
cause a purge gas to be introduced to the equipment piece so as to displace any fluid from the process stream in the space.

19. The apparatus of claim 18, further comprising:
a sensor configured to be utilized to determine a moisture content of the displaced fluid.

20. The apparatus of claim 18, wherein the controller is further configured to:
stop a flow of the purge gas when the moisture content of the displaced fluid has been determined to be below a threshold.
